(19) United States
(12) Patent Application Publication
(10) Pub. No.: US 2016/0001669 A1
(43) Pub. Date: Jan. 7, 2016

(54) Vehicle And Contactless Power Feeding System

(71) Applicant: Shinji ICHIKAWA, Toyota-shi (JP)

(72) Inventor: Shinji ICHIKAWA, Toyota-shi (JP)

(73) Assignee: TOYOTA JIDOSHA KABUSHIKI KAISHA, Toyota-shi, Aichi-ken (JP)

(21) Appl. No.: 14/653,518

(22) PCT Filed: Mar. 22, 2013
(86) PCT No.: PCT/JP2013/058296

§ 371 Date: Jun. 18, 2015

(51) Int. Cl. B60L 11/18; H02J 17/00; H02J 5/00

(52) U.S. Cl. CPC B60L 11/1829; H02J 5/005; H02J 17/00

(57) ABSTRACT

A contactless power feeding system is capable of supplying power from a power transmission unit to a power reception unit in a contactless manner. The contactless power feeding system includes a raising and lowering mechanism that moves the power reception unit from a standby position toward the power transmission unit, and a vehicle ECU. The vehicle ECU performs first detection operation of detecting a position of the power transmission unit when the power reception unit is located in the standby position, and second detection operation of detecting a position of the power transmission unit when the power reception unit is located in a power reception position. The vehicle ECU causes the power transmission unit to start power transmission when it is detected that the power transmission unit is located within a predetermined range in both of the first and second detection operations.

### TECHNICAL FIELD

The present invention relates to vehicles and contactless power feeding systems, and more particularly to an alignment technique between a power transmission unit and a power reception unit in a contactless power feeding system.

### BACKGROUND ART

In recent years, attention has been drawn to contactless and wireless power transfer without a power code or a power transmission cable. It has been proposed to apply this power transfer to an electric car, a hybrid vehicle and the like in which a power storage device mounted thereon can be charged with power from a power supply outside of the vehicle (hereinafter also referred to as an “external power supply”).

In such a contactless power feeding system, proper alignment between the power transmission and the power reception is important so as to improve power transfer efficiency. Some systems have been proposed in which a mechanism is provided that is capable of moving a power transmission unit or a power reception unit so as to bring those units closer to each other.

Japanese Patent Laying-Open No. 2011-036107 (PTD 1) discloses a charging system of transferring power in a contactless manner between a power reception coil provided on a vehicle and a power transmission coil provided on the ground, in which a position adjustment unit is provided that adjusts a position of the power transmission coil such that the power transmission coil and the power reception coil have positional relation in which they are electromagnetically coupled together.

Japanese Patent Laying-Open No. 2011-120387 (PTD 2) and Japanese Patent Laying-Open No 2011-193617 (PTD 3) each disclose a contactless power feeding system of a vehicle, in which the vehicle is provided with a raising and lowering device that raises and lowers a power reception coil provided on the vehicle to bring the power reception coil closer to a power transmission coil.

### CITATION LIST

### Patent Documents

PTD 1: Japanese Patent Laying-Open No. 2011-036107

PTD 2: Japanese Patent Laying-Open No. 2011-120387

PTD 3: Japanese Patent Laying-Open No. 2011-193617

### SUMMARY OF INVENTION

### Technical Problem

When charging a power storage device mounted on a vehicle in a contactless power feeding system, it is important to park the vehicle such that positional relation between a power transmission unit and a power reception unit during power transfer is suitable for the power transfer, in a parking space provided with a power transmission device. If the power transmission unit or the power reception unit is configured in a movable manner after the parking, as is disclosed in the patent documents mentioned above, the final positional relation between the power transmission unit and the power reception unit during power transfer needs to fall within a predetermined range so as to obtain desired power transfer efficiency.

If the positional relation between the power transmission unit and the power reception unit is inappropriate, the power transfer is carried out at reduced power transfer efficiency, resulting in wasteful release of power from the power transmission device, and an extended charging time.

The present invention has been made to solve such a problem, and an object of the present invention is to ensure desired power transfer efficiency in a contactless power feeding system provided with a moving device that moves a power transmission unit or a power reception unit.

### Solution to Problem

A vehicle according to the present invention is capable of receiving power from a power transmission device in a contactless manner. The vehicle includes a power reception unit that receives power from a power transmission unit included in the power transmission device in a contactless manner, a moving device configured to move the power reception unit from a standby position in a direction toward the power transmission unit, and a control device. The control device is configured to perform first detection operation of detecting a position of the power transmission unit when the power reception unit is located in the standby position, and second detection operation of detecting a position of the power transmission unit when the power reception unit is located in a position closer to the power transmission unit than in the standby position. The control device causes the power transmission device to start power transmission when it is detected that the power transmission unit is located within a first predetermined range in the first detection operation and when it is detected that the power transmission unit is located within a second predetermined range in the second detection operation.

Preferably, the vehicle further includes a detection unit for detecting the power transmission unit. The control device performs the first detection operation by means of the detection unit, and performs the second detection operation by means of the power reception unit.

Preferably, when the vehicle is located in a position capable of receiving the power transmission from the power transmission device, a distance between the detection unit and the power transmission unit is shorter than a distance between the standby position and the power transmission unit.

Preferably, the control device performs the second detection operation after the power reception unit has been moved to a planned position where power reception is started.

Preferably, the detection unit includes a plurality of magnetic sensors configured to detect magnetism of an electromagnetic field generated by the power transmission from the power transmission unit. The control device recognizes the position of the power transmission unit based on distribution of the magnetism detected by the plurality of magnetic sensors.

Preferably, the control device causes the power transmission unit to start the power transmission in accordance with a timer value, the timer value being determined based on information about a time to start the power transmission set by a user. The control device performs the second detection operation in response to lapse of a time corresponding to the timer value.

Preferably, a difference between a natural frequency of the power transmission unit and a natural frequency of the power reception unit is ±10% or less of the natural frequency of the power transmission unit or the natural frequency of the power reception unit.

Preferably, a coefficient of coupling between the power transmission unit and the power reception unit is not less than 0.6 and not more than 0.8.

Preferably, the power reception unit receives power from the power transmission unit through at least one of a magnetic field formed between the power reception unit and the power transmission unit and oscillating at a specific frequency, and art electric field formed between the power reception unit and the power transmission unit and oscillating at a specific frequency.

A contactless power feeding system according to the present invention supplies power from a power transmission unit to a power reception unit in a contactless manner. The contactless power feeding system includes a moving device configured to move at least one of the power transmission unit and the power reception unit from a standby position in a direction in which the power transmission unit and the power reception unit are brought closer to each other, and a control device. The control device is configured to perform first detection operation of detecting positional relation between the power transmission unit and the power reception unit when the power transmission unit and the power reception unit are located in the standby positions, and second detection operation of detecting the positional relation when a distance between the power transmission unit and the power reception unit is shorter than the distance with the power transmission unit and the power reception unit being in the standby positions. The control device causes the power transmission unit to start power transmission, when it is detected that the positional relation satisfies a first predetermined condition in the first detection operation and when it is detected that the positional relation satisfies a second predetermined condition in the second detection operation.

### Advantageous Effects of Invention

According to the present invention, in the contactless power feeding system provided with the moving device that moves the power transmission unit or the power reception unit, the positional relation between the power transmission unit and the power reception unit is confirmed during parking operation, and when the power transmission unit and the power reception unit are brought closer to each other by the moving device. The power transfer is carried out after it is confirmed that the positional relation between the power transmission unit and the power reception unit satisfies the predetermined condition in each case. Consequently, the power transfer can be carried out while desired power transfer efficiency is ensured.

### BRIEF DESCRIPTION OF DRAWINGS

FIG. 1 is an overall configuration diagram of a contactless power feeding system of a vehicle according to an embodiment of the present invention.

FIG. 2 is a diagram for illustrating the operation of a raising and lowering mechanism shown in FIG. 1.

FIG. 3 is a first diagram for illustrating positional relation between position detection sensors and a power transmission unit.

FIG. 4 is a second diagram for illustrating the positional relation between the position detection sensors and the power transmission unit.

FIG. 5 is an equivalent circuit diagram during power transfer from a power transmission device to the vehicle.

FIG. 6 is a diagram showing a simulation model of a power transfer system.

FIG. 7 is a diagram showing relation between deviation in natural frequency of the power transmission unit and a power reception unit, and power transfer efficiency.

FIG. 8 is a graph showing relation between the power transfer efficiency when an air gap is changed with the natural frequency being fixed, and a frequency of current supplied to the power transmission unit.

FIG. 9 is a diagram showing relation between a distance from an electric current source (magnetic current source) and the strength of an electromagnetic field.

FIG. 10 is a diagram for illustrating a summary of position confirmation control in this embodiment.

FIG. 11 is a diagram for illustrating a summary of position confirmation control using a timer function in this embodiment.

FIG. 12 is a flowchart for illustrating a process of position confirmation control in this embodiment.

### DESCRIPTION OF EMBODIMENTS

An embodiment of the present invention will be described below in detail with reference to the drawings, in which the same or corresponding parts are designated by the same characters and description thereof will not be repeated.

(Configuration of Contactless Power Feeding System)

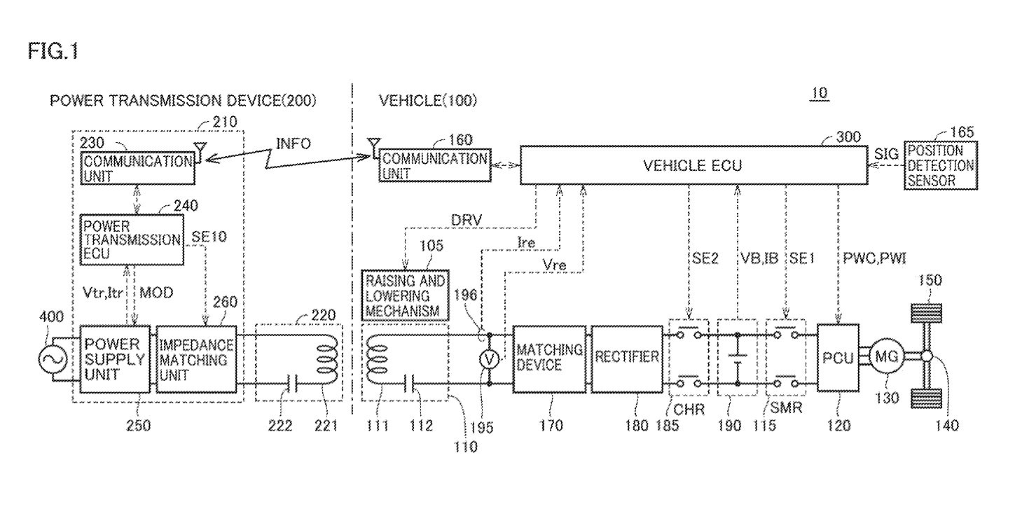

FIG. 1 is an overall configuration diagram of a contactless power feeding system 10 according to this embodiment. Referring to FIG. 1, contactless power feeding system 10 includes a vehicle 100 and a power transmission device 200.

Power transmission device 200 includes a power supply device 210 and a power transmission unit 220. Power supply device 210 generates AC power having a predetermined frequency. By way of example, power supply device 210 generates high-frequency AC power with power received from a commercial power supply 400, and supplies the generated AC power to power transmission unit 220. Power transmission unit 220 then outputs the power to a power reception unit 110 of vehicle 100 in a contactless manner through an electromagnetic field generated around power transmission unit 220.

Power supply device 210 includes a communication unit 230, a power transmission ECU 240 serving as a control device, a power supply unit 250, and an impedance matching unit 260. Power transmission unit 220 includes a resonant coil 221 and a capacitor 222.

Power supply unit 250 is controlled by a control signal MOD from power transmission ECU 240, and converts power received from an AC power supply such as commercial power supply 400 to high-frequency power. Power supply unit 250 then supplies the converted high-frequency power to resonant coil 221 through impedance matching unit 260.

Power supply unit 250 also outputs a power transmission voltage Vtr and a power transmission current Itr detected by a voltage sensor and a current sensor not shown, respectively, to power transmission ECU 240.

Impedance matching unit 260 is for matching an input impedance or power transmission unit 220, and typically includes a reactor and a capacitor. Impedance matching unit 260 is controlled by a control signal SE10 from power transmission ECU 240.

Resonant coil 221 transfers the power transmitted from power supply unit 250 to a resonant coil 111 included in power reception unit 110 of vehicle 100 in a contactless manner. Resonant coil 221 and capacitor 222 form an LC resonance circuit. Power transfer between power reception unit 110 and power transmission unit 220 will be described later with reference to FIG. 4.

Communication unit 230 is a communication interface for conducting radio communication between power transmission device 200 and vehicle 100, and provides and receives information INFO to and from a communication unit 160 of vehicle 100. Communication unit 230 receives vehicle information transmitted from communication unit 160 of vehicle 100, signals indicating the start and stop of power transmission, and the like, and outputs the received pieces of information to power transmission ECU 240. Communication unit 230 also transmits information such as power transmission voltage Vtr and power transmission current Itr from power transmission ECU 240 to vehicle 100.

Although not shown in FIG. 1, power transmission ECU 240 includes a CPU (Central Processing Unit), a storage device, an input/output buffer, and the like. Power transmission ECU 240 inputs the signals from various sensors and outputs the control signal to each device while controlling each device in power supply device 210. It is to be noted that the above-described control is not limited to the process by software, but can be carried out by dedicated hardware (an electronic circuit).

Vehicle 100 includes a raising, and lowering mechanism 105, power reception unit 110, a matching device 170, a rectifier 180, a charging relay CHR 185, a power storage device 190, a system main relay SMR 115, a power control unit (PCU) 120, a motor generator 130, as motive power transmission gear 140, drive wheels 150, a vehicle ECU (Electronic Control Unit) 300 serving as a control device, communication unit 160, a voltage sensor 195, a current sensor 196, and a position detection sensor 165.

Although an electric car is described as an example of vehicle 100 in this embodiment, the configuration of vehicle 100 is not limited thereto as long as it is capable of running with power stored in a power storage device. Other examples of vehicle 100 include a hybrid vehicle including an engine and a fuel cell vehicle including a fuel cell.

Power reception unit 110 is provided near a floor panel of vehicle 100, and includes resonant coil 111 and a capacitor 112.

Resonant coil 111 receives power from resonant coil 221 included in power transmission device 200 in a contactless manner. Resonant coil 111 and capacitor 112 form an LC resonance circuit.

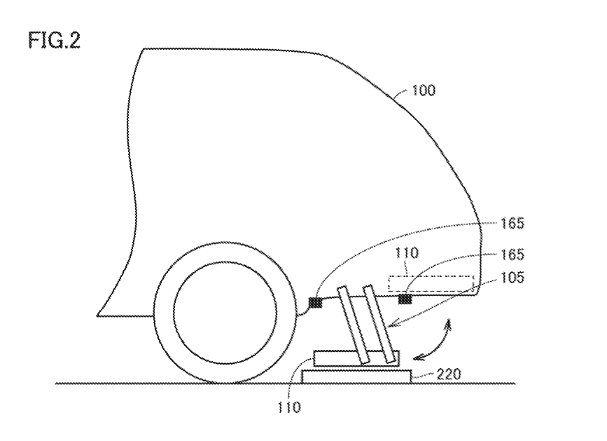

Power reception unit 110 is mounted on raising and lowering mechanism 105. As shown in FIG. 2, raising and lowering mechanism 105 is a moving device for moving power reception unit 110 from a standby position (broken line) to a planned power reception position facing power transmission unit 220 (hereinafter also referred to as a “power reception position”) (solid line) by means of a link mechanism, for example. Raising and lowering mechanism 105 is driven by a not-shown motor, for example, after vehicle 100 has been parked in a predetermined position in a parking space, to move power reception unit 110 from the standby position to the power reception position.

It is to be noted that the power reception position may be set to a predetermined height from power transmission unit 220 or may be a position where power reception unit 110 comes in contact with power transmission unit 220.

When vehicle 100 is parked in the predetermined position in the parking space, as shown in FIG. 2, a distance between position detection sensors 165 and power transmission unit 220 (or the power reception position) is shorter than a distance between the standby position and power transmission unit 220 (or the power reception position).

Furthermore, raising and lowering mechanism 105 includes a ratchet mechanism and is configured to limit the movement of power reception unit 110 below the power reception position but to allow the movement of power reception unit 110 above the power reception position. Consequently, if the vehicle height is lowered, variation in spacing between the floor panel and power reception unit 110 can be absorbed.

The power received by resonant coil 111 is output to rectifier 180 through matching device 170. Matching device 170 typically includes a reactor and a capacitor, and matches an input impedance of a load supplied with the power received by resonant coil 111.

Rectifier 180 rectifies the AC power received from resonant coil 111 through matching device 170, and outputs the rectified DC power to power storage device 190. Rectifier 180 may include, for example, a diode bridge and a smoothing capacitor (neither shown). A so-called switching regulator that performs rectification by switching control can also be used as rectifier 180. If rectifier 180 is included in power reception unit 110, the rectifier is more preferably a stationary rectifier such as a diode bridge so as to prevent malfunction and the like of a switching element associated with a generated electromagnetic field.

CHR 185 is electrically connected between rectifier 180 and power storage device 190. CHR 185 is controlled by a control signal SE2 from vehicle ECU 300, and switches between supply and interruption of power from rectifier 180 to power storage device 190.

Power storage device 190 is an electric power storage component configured in a chargeable/dischargeable manner. For example, power storage device 190 includes a secondary battery such as a lithium-ion battery, a nickel-metal hydride battery or a lead-acid battery, or a power storage element such as an electric double layer capacitor.

Power storage device 190 is connected to rectifier 180. Power storage device 190 stores the power received by power reception unit 110 and rectified by rectifier 180. Power storage device 190 is also connected to PCU 120 through SMR 115. Power storage device 190 supplies PCU 120 with power for the generation of driving power of the vehicle. Power storage device 190 also stores power generated by motor generator 130. The output voltage of power storage device 190 is, for example, approximately 200 V.

Although not shown, power storage device 190 is provided with a voltage sensor and a current sensor for detecting a voltage VB of power storage device 190 and a current IB input to and output from power storage device 190, respectively. The detected values from these sensors are output to vehicle ECU 300. Vehicle ECU 300 calculates an SOC (State of Charge) of power storage device 190 based on voltage VB and current IB.

SMR 115 is electrically connected between power storage device 190 and PCU 120. SMR 115 is controlled by a control signal SE1 from vehicle ECU 300, and switches between supply and interruption of power between power storage device 190 and PCU 120.

Although not shown, PCU 120 includes a converter and an inverter. The converter is controlled by a control signal PWC from vehicle ECU 300, and converts a voltage from power storage device 190. The inverter is controlled by a control signal PWI from vehicle ECU 300, and drives motor generator 130 with the power converted by the converter.

Motor generator 130 is an AC rotating electric machine, for example, a permanent magnet type synchronous motor including a rotor having a permanent magnet buried therein.

Output torque of motor generator 130 is transmitted to drive wheels 150 through motive power transmission gear 140. Vehicle 100 runs with this torque. Motor generator 130 can generate power by a rotational force of drive wheels 150 during regenerative braking of vehicle 100. The generated power is converted by PCU 120 into charging power of power storage device 190.

In a hybrid vehicle including an engine (not shown) in addition to motor generator 130, required driving power of the vehicle is generated by cooperatively operating the engine and motor generator 130. In this case, power storage device 190 can be charged with power generated by the rotation of the engine.

Communication unit 160 is a communication interface for conducting radio communication between vehicle 100 and power transmission device 200, and provides and receives information INFO to and from communication unit 230 of power transmission device 200. Information INFO output from communication unit 160 to power transmission device 200 includes vehicle information from vehicle ECU 300, signals indicating the start and stop of power transmission, an indication to switch impedance matching unit 260 of power transmission device 200, and the like.

Although not shown in FIG. 1, vehicle ECU 300 includes a CPU, a storage device, and an input/output buffer. Vehicle ECU 300 inputs the signals from various sensors and outputs the control signal to each device while controlling each device in vehicle 100. It is to be noted that the above-described control is not limited to the process by software, but can be carried out by dedicated hardware (an electronic circuit).

Position detection sensor 165 is provided, for example, on a lower surface of the floor panel of vehicle 100. Position detection sensor 165 is a sensor for detecting power transmission unit 220 so as to confirm a parking position in a parking space provided with power transmission unit 220. Position detection sensor 165 is a magnetic detection sensor, for example, and detects the magnitude of a magnetic field generated by power transmitted from power transmission unit 220 for the position detection during parking operation (hereinafter also referred to as “test power transmission”), then outputs a detection signal SIG to ECU 300. ECU 300 determines whether or not the parking position is appropriate based on detection signal SIG from position detection sensor 165, and prompts the user to stop the vehicle. Alternatively, if vehicle 100 has an automatic parking function, ECU 300 causes an automatic stop of the vehicle based on detection signal SIG.

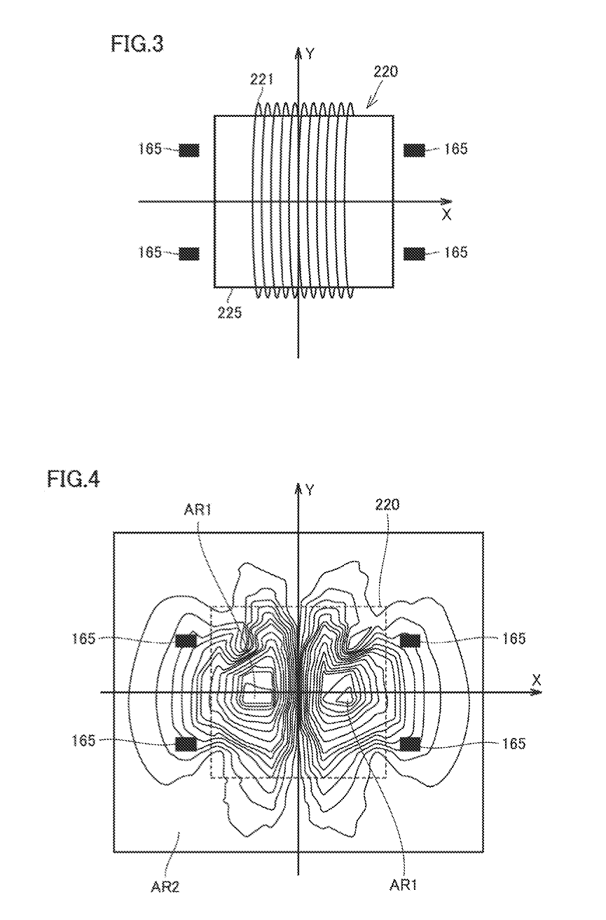

FIG. 3 is diagram showing an example of positional relation between power transmission unit 220 and position detection sensors 165 when vehicle 100 is properly parked relative to power transmission unit 220. In the example of FIG. 3, resonant coil 221 for power transmission of power transmission unit 220 is wound around a ferrite core 225 such that its winding axis is in a horizontal direction (X-axis direction in FIG. 3). Four sensors are used as position detection sensors 165.

FIG. 4 shows an example of simulation of distribution of a magnetic field generated when power transmission unit 220 as shown in FIG. 3 performs power transmission. In FIG. 4, the magnetic field, distribution is represented as contour lines, with the magnetic field increasing in strength from a surrounding region AR2 toward a region AR1.

Position detection sensors 165 are arranged in orthogonal coordinates (X-Y axis) having the winding center of resonant coil 221 for power transmission as the origin, such that they are at the same distance from the origin in the X axis direction and at the same distance from the origin in the Y axis direction, namely, such that they are symmetric with respect to the origin. Consequently, when vehicle 100 is parked in an appropriate position relative to power transmission unit 220, the magnetic field detected by position detection sensors 165 will have substantially the same magnitude. Accordingly, during the parking operation, it can be determined whether or not power transmission unit 220 is located within a first predetermined range based on the difference in magnitude of the magnetic field detected by position detection sensors 165.

It is to be noted that position detection sensor 165 is not limited to a magnetic detection sensor as described above, but may be an RFID reader for detecting RFID attached to power transmission unit 220, or may be a distance sensor for detecting a height difference of power transmission unit 220 or the height of a reference point. When these other types of sensors are used, the position is recognized from distribution of reception strength from each RFID, or the position is recognized from distribution of height detected by each distance sensor.

In the configuration provided with raising and lowering mechanism 105 as in this embodiment, power reception unit 110 is moved from the standby position to the power reception position. Thus, when power reception unit 110 is stored in the standby position such as during the parking operation, the position detection using power reception unit 110 is difficult. Therefore, position detection sensor 165 is required so as to detect the position of power transmission unit 220 during the parking operation.

Referring back to FIG. 1, voltage sensor 195 is connected in parallel with resonant coil 111, and detects a power reception voltage Vre received by power reception unit 110. Current sensor 196 is provided on a power line that connects resonant coil 111 and matching device 170 together, and detects a power reception current Ire. The detected values of power reception voltage Vre and power reception current Ire are transmitted to vehicle ECU 300 for use in calculation of power transfer efficiency and the like.

Although FIG. 1 shows a configuration where power reception unit 110 and power transmission unit 220 are provided with resonant coils 111 and 221, power reception unit 110 and power transmission unit 220 may be additionally provided with electromagnetic induction coils 113 and 223, respectively, that are configured to provide and receive power to and from the resonant coils by electromagnetic induction. In this case, although not shown in FIG. 1, the electromagnetic induction coil is connected to power supply unit 250 in power transmission unit 220, and transmits power from power supply unit 250 to resonant coil 221 by electromagnetic induction. In addition, electromagnetic induction coil 113 is connected to rectifier 180 in power reception unit 110, and extracts the power received by resonant coil 111 by electromagnetic induction and transmits the power to rectifier 180.

(Principle of Power Transfer)

Referring, now to FIGS. 5 to 9, the principle of power transfer in a contactless manner is described, it is to be noted that FIGS. 5 to 9 illustrate an example where a power reception unit and a power transmission unit are provided with electromagnetic induction coils. FIG. 5 is an equivalent circuit diagram during power transfer from power transmission device 200 to vehicle 100. Referring to FIG. 5 power transmission unit 220 of power transmission device 200 includes resonant coil 221, capacitor 222, and electromagnetic induction coil 223.

Electromagnetic induction coil 223 is provided substantially coaxially with resonant coil 221, for example, at a predetermined distance from resonant coil 221. Electromagnetic induction coil 223 is magnetically coupled to resonant coil 221 by electromagnetic induction, and supplies high-frequency power supplied from power supply device 210 to resonant coil 221 by electromagnetic induction.

Resonant coil 221 and capacitor 222 form an LC resonance circuit. An LC resonance circuit is also formed in power reception unit 110 of vehicle 100, as will be described later. The difference between a natural frequency of the LC resonance circuit formed of resonant coil 221 and capacitor 222 and a natural frequency of the LC. resonance circuit of power reception unit 110 is ±10% or less of the former natural frequency or the latter natural frequency. Resonant coil 221 receives the power from electromagnetic induction coil 223 by electromagnetic induction, and transmits the power to power reception unit 110 of vehicle 100 in a contactless manner.

Electromagnetic induction coil 223 is provided to facilitate the power feeding from power supply device 210 to resonant coil 221, and power supply device 210 may be connected directly to resonant coil 221 without providing electromagnetic induction coil 223. Capacitor 222 is provided to adjust the natural frequency of the resonance circuit, and capacitor 222 may not be provided if a desired natural frequency is obtained by utilizing stray capacitance of resonant coil 221.

Power reception unit 110 of vehicle 100 includes resonant coil 111, capacitor 112, and electromagnetic induction coil 113. Resonant coil 111 and capacitor 112 form an LC resonance circuit. As described above, the difference between the natural frequency of the LC resonance circuit formed of resonant coil 111 and capacitor 112 and the natural frequency of the LC resonance circuit formed of resonant coil 221 and capacitor 222 in power transmission unit 220 of power transmission device 200 is ±10% of the former natural frequency or the latter natural frequency. Resonant coil 111 receives power from power transmission unit 220 of power transmission device 200 in a contactless manner.

Electromagnetic induction coil 113 is provided substantially coaxially with resonant coil 111, for example, at a predetermined distance from resonant coil 111. Electromagnetic induction coil 113 is magnetically coupled to resonant coil 111 by electromagnetic induction, and extracts the power received by resonant coil 111 by electromagnetic induction and outputs the power to an electrical load device 118. It is to be noted that electrical load device 118 is electrical equipment that utilizes the power received by power reception unit 110, and specifically, collectively represents electrical equipment at a stage subsequent to rectifier 180 (FIG. 1).

Electromagnetic induction coil 113 is provided to facilitate the extraction of power from resonant coil 111, and rectifier 180 may be connected directly to resonant cod 111 without providing electromagnetic induction coil 113. Capacitor 112 is provided to adjust the natural frequency of the resonance circuit, and capacitor 112 may not be provided if a desired natural frequency is obtained by utilizing stray capacitance of resonant coil 111. in power transmission device 200, high-frequency AC power is supplied from power supply device 210 to electromagnetic induction coil 223, and the power is supplied to resonant coil 221 through electromagnetic induction coil 223. This causes the energy (electric power) to be transferred from resonant coil 221 to resonant coil 111 through a magnetic field formed between resonant coil 221 and resonant coil 111 of vehicle 100. The energy (electric power) transferred to resonant coil 111 is extracted by electromagnetic induction coil 113 and transferred to electrical load device 11 of vehicle 100.

As described above, in this power transfer system, the difference between the natural frequency of power transmission unit 220 of power transmission device 200 and the natural frequency of power reception unit 110 of vehicle 100 is ±10% or less of the natural frequency of power transmission unit 220 or the natural frequency of power reception unit 110. By setting the natural frequencies of power transmission unit 220 and power reception unit 110 within such a range, the power transfer efficiency can be improved. When the difference in natural frequency becomes greater than ±10%, the power transfer efficiency becomes lower than 10%, which may disadvantageously result in an extended time of power transfer and the like.

The “natural frequency of power transmission unit 220 (power reception unit 110)” refers to an oscillation frequency at which the electric circuit (resonance circuit) forming power transmission unit 220 (power reception unit 110) freely oscillates. The natural frequency when the damping force or the electric resistance is set at substantially zero in the electric circuit (resonance circuit) forming power transmission unit 220 (power reception unit 110) is also referred to as a “resonance frequency of power transmission unit 220 (power reception unit 110).”

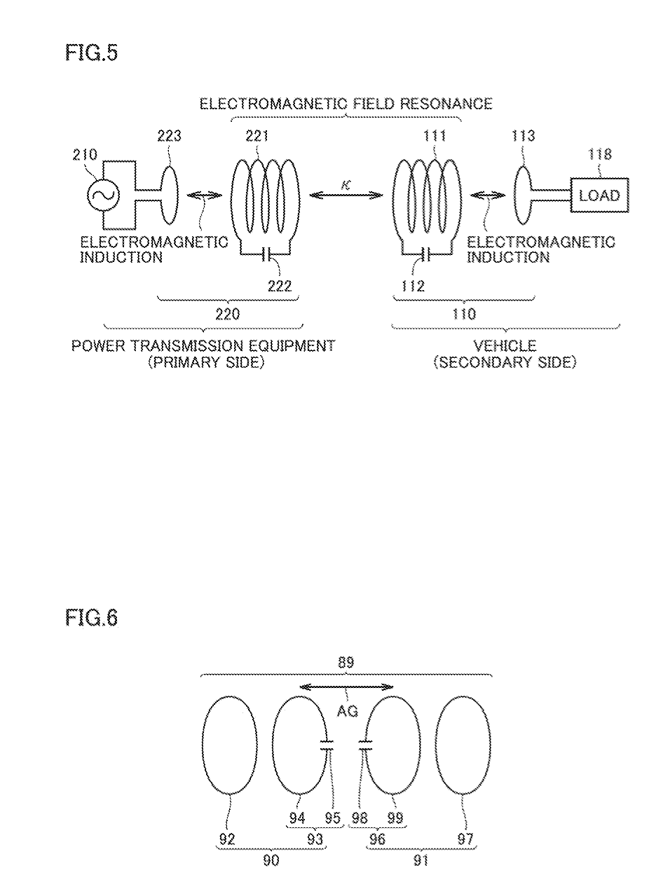

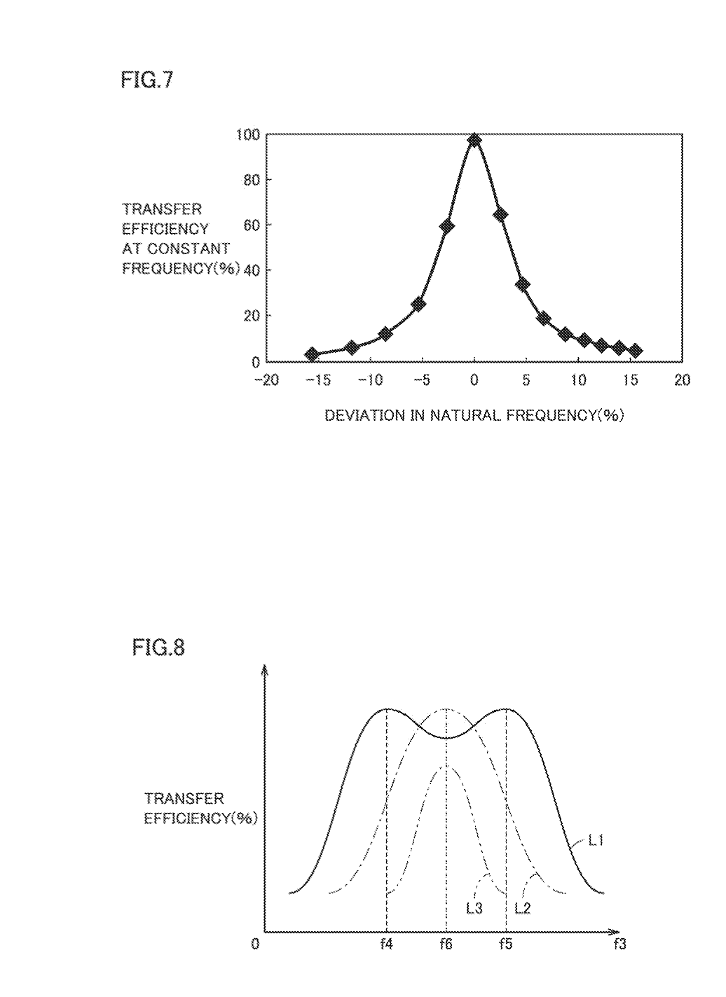

Referring to FIGS. 6 and 7, the following describes a result of simulation in which relation is analyzed between the difference in natural frequency and power transfer efficiency. FIG. 6 is a diagram showing, a simulation model of a power transfer system. FIG. 7 is a diagram showing relation between deviation in natural frequency of a power transmission unit and a power reception unit, and the power transfer efficiency.

Referring to FIG. 6, a power transfer system 89 includes a power transmission unit 90 and a power reception unit 91. Power transmission unit 90 includes a first coil 92 and a second coil 93. Second coil 93 includes a resonant coil 94 and a capacitor 95 provided on resonant coil 94. Power reception unit 91 includes a third coil 96 and a fourth coil 97. Third coil 96 includes a resonant coil 99 and a capacitor 98 connected to resonant coil 99.

Assume that the inductance of resonant coil 94 is inductance Lt and the capacitance of capacitor 95 is capacitance C1. Assume that the inductance of resonant coil 99 is inductance Lr and the capacitance of capacitor 98 is capacitance C2. By setting each of the parameters in this way, a natural frequency f1 of second coil 93 is indicated by the following formula (1) and a natural frequency f2 of third coil 96 is indicated by the following formula (2):

f1=1/{2π(Lt×C1)^{1/2}} (1)

f2=1/{2π(Lr×C2)^{1/2}} (2)

Here, FIG. 7 shows relation between the power transfer efficiency and the deviation in natural frequency between second coil 93 and third coil 96 when only inductance Lt is changed with inductance Lr and capacitances C1, C2 being fixed. In this simulation, relative positional relation between resonant coil 94 and resonant coil 99 is fixed, and the frequency of current supplied to second coil 93 is constant.

In the graph shown in FIG. 7, the horizontal axis represents the deviation (%) in natural frequency whereas the vertical axis represents the power transfer efficiency (%) of current at the constant frequency. The deviation (%) in natural frequency is indicated by the following formula (3):

(Deviation in natural frequency)={(f1−f2)/f2}×100 (%) (3)

As is apparent from FIG. 7, when the deviation (%) in natural frequency is 0%, the power transfer efficiency is close to 100%. When the deviation (%) in natural frequency is ±5%, the power transfer efficiency is close to 40%. When the deviation (%) in natural frequency is ±10%, the power transfer efficiency is close to 10%. When the deviation (%) in natural frequency is 5%, the power transfer efficiency is close to 5%. Thus, it is understood that the power transfer efficiency can be improved to a practical level by setting the natural frequency of each of second coil 93 and third coil 96 such that the absolute value of the deviation (%) in natural frequency (difference in natural frequency) falls within a range of 10% or less of the natural frequency of third coil 96. Further, it is more preferable to set the natural frequency of each of second coil 93 and third coil 96 such that the absolute value of the deviation (%) in natural frequency is 5% or less of the natural frequency of third coil 96, so that the power transfer efficiency can be further improved. It is to be noted that electromagnetic field analysis software (JMAG® provided by JSOL Corporation) is employed as simulation software.

Referring back to FIG. 5, power transmission unit 220 of power transmission device 200 and power reception unit 110 of vehicle 100 transmit and receive power in a contactless manner through at least one of a magnetic field formed between power transmission unit 220 and power reception unit 110 and oscillating at a specific frequency, and an electric field formed between power transmission unit 220 and power reception unit 110 and oscillating at a specific frequency. A coupling coefficient κ between power transmission unit 220 and power reception unit 110 is preferably 0.1 or less. By resonating power transmission unit 220 and power reception unit 110 with each other through the electromagnetic field, power is transferred from power transmission unit 220 to power reception unit 110.

Here, the following describes the magnetic field formed around power transmission unit 220 and having the specific frequency. The “magnetic field having the specific frequency” is typically relevant to the power transfer efficiency and the frequency of current supplied to power transmission unit 220. First described is relation between the power transfer efficiency and the frequency of the current supplied to power transmission unit 220. The power transfer efficiency when transferring power from power transmission unit 220 to power reception unit 110 varies depending on various factors such as a distance between power transmission unit 220 and power reception unit 110. For example, the natural frequencies (resonance frequencies) of power transmission unit 220 and power reception unit 110 are assumed as f0, the frequency of the current supplied to power transmission unit 220 is assumed as f3, and an air gap between power transmission unit 220 and power reception unit 110 is assumed as an air gap AG.

FIG. 8 is a graph indicating relation between the power transfer efficiency when air gap AG is changed with natural frequency 10 being fixed, and frequency f3 of the current supplied to power transmission unit 220. Referring to FIG. 8, the horizontal axis represents frequency f3 of the current supplied to power transmission unit 220 whereas the vertical axis represents the power transfer efficiency (%). An efficiency curve L1 schematically represents relation between the power transfer efficiency when air gap AG is small and frequency f3 of the current supplied to power transmission unit 220. As indicated by efficiency curve L1, when air gap AG is small, peaks of the power transfer efficiency appear at frequencies f4, f5 (f4<f5) When air gap AG is made larger, the two peaks at which the power transfer efficiency becomes high are changed to come closer to each other. Then, as indicated by an efficiency curve L2, when air gap AG is made larger than a predetermined distance, one peak of the power transfer efficiency appears. The peak of the power transfer efficiency appears when the current supplied to power transmission unit 220 has a frequency f6. When air gap AG is made further larger from the state of efficiency curve L2, the peak of the power transfer efficiency becomes smaller as indicated by an efficiency curve L3.

For example, as a technique of improving, the power transfer efficiency, the following techniques can be considered. A first technique is to change a characteristic of the power transfer efficiency between power transmission unit 220 and power reception unit 110 by changing the capacitances of capacitor 222 and capacitor 112 in accordance with air gap AG with the frequency of the current supplied to power transmission unit 220 being constant. Specifically, with the frequency of the current supplied to power transmission unit 220 being constant, the capacitances of capacitor 222 and capacitor 112 are adjusted to attain a peak of the power transfer efficiency. In this technique, irrespective of the size of air gap AG, the frequency of the current flowing through power transmission unit 220 and power reception unit 110 is constant.

A second technique is to adjust, based on the size of air gap AG, the frequency of the current supplied to power transmission unit 220. For example, when the power transfer characteristic corresponds to efficiency curve L1, power transmission unit 220 is supplied with current having frequency f4 or f5. When the frequency characteristic corresponds to efficiency curve L2 or L3, power transmission unit 220 is supplied with current having frequency f6. In this case, the frequency of the current flowing through power transmission unit 220 and power reception unit 110 is varied in accordance with the size of air gap AG.

In the first technique, the frequency of the current flowing through power transmission unit 220 becomes a fixed, constant frequency. In the second technique, the frequency thereof flowing through power transmission unit 220 becomes a frequency appropriately varied according to air gap AG. With the first technique, the second technique, or the like, power transmission unit 220 is supplied with a current haying a specific frequency set to attain high power transfer efficiency. Because the current having the specific frequency flows through power transmission unit 220, a magnetic field (electromagnetic field) oscillating at the specific frequency is formed around power transmission unit 220. Power reception unit 110 receives power from power transmission unit 220 via the magnetic field formed between power reception unit 110 and power transmission unit 220 and oscillating at the specific frequency. Therefore, “the magnetic field oscillating at the specific frequency” is not necessarily a magnetic field having a fixed frequency. It is to be noted that in the above-described example, the frequency of the current supplied to power transmission unit 220 is set based on air gap AG, but the power transfer efficiency also varies according to other factors such as deviation in the horizontal direction between power transmission unit 220 and power reception unit 110, so that the frequency of the current supplied to power transmission unit 220 may be adjusted based on the other factors.

It is to be noted that the example employing a helical coil as the resonant coil has been described above, but when an antenna such as a meander line antenna is employed as the resonant coil, an electric field having the specific frequency is formed around power transmission unit 220 as a result of flow of the current having the specific frequency through power transmission unit 220. Through this electric field, power transfer is carried out between power transmission unit 220 and power reception unit 110.

In this power transfer system, efficiency in power transmission and power reception is unproved by employing a near field (evanescent field) in which an “electrostatic magnetic field” of the electromagnetic field is dominant.

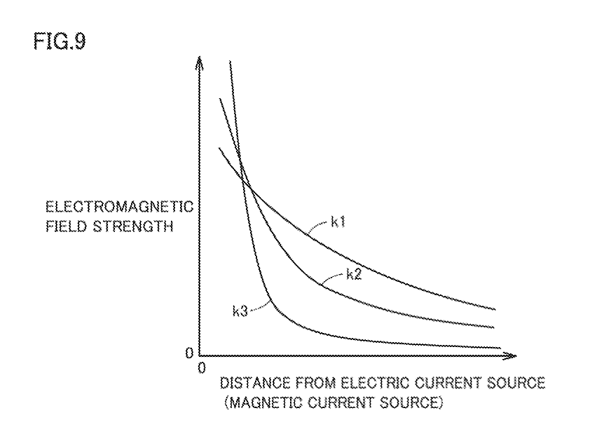

FIG. 9 shows relation between a distance from an electric current source (magnetic current source) and the strength of an electromagnetic field. Referring to FIG. 9, the electromagnetic field is constituted of throe components. A curve k1 represents a component in inverse proportion to the distance from the wave source, and is referred to as a “radiation electromagnetic field.” A curve k2 represents a component in inverse proportion to the square of the distance from the wave source, and is referred to as an “induction electromagnetic field.” A curve k3 represents a component in inverse proportion to the cube of the distance from the wave source, and is referred to as an “electrostatic magnetic field.” Assuming that the wavelength of the electromagnetic field is represented by “λ”, λ/2π represents a distance in which the strengths of the “radiation electromagnetic field,” the “induction electromagnetic field,” and the “electrostatic magnetic field” are substantially the same.

The “electrostatic magnetic field” is a region in which the strength of the electromagnetic wave is abruptly decreased as the distance is farther away from the wave source. In the power transfer system according to this embodiment, the near field (evanescent field), in which this “electrostatic magnetic field” is dominant, is utilized for transfer of energy (electric power). In other words, by resonating power transmission unit 220 and power reception unit 110 (for example, a pair of LC resonant coils) having close natural frequencies in the near field in which the “electrostatic magnetic field” is dominant, the energy (electric power) is transferred from power transmission unit 220 to the other side, i.e., power reception unit 110. This “electrostatic magnetic field” does not propagate energy to a distant place. Hence, the resonance method allows for power transmission with less energy loss as compared with the electromagnetic wave in which the “radiation electromagnetic field” propagating energy to a distant place is utilized to transfer energy (electric power).

Thus, in this power transfer system, by resonating power transmission unit 220 and power reception unit 110 with each other through the electromagnetic field, power is transferred in a contactless manner between power transmission unit 220 and power reception unit 110. The coupling coefficient (κ) between power transmission unit 220 and power reception unit 110 is about 0.3 or less, preferably, 0.1 or less, for example. Naturally, the coupling coefficient (κ) may also fall within a range of about 0.1 to about 0.3. The coupling coefficient (κ) is not limited to such a value, and various values to attain excellent power transfer can be employed.

It is to be noted that coupling coefficient κ vanes with the distance between the power transmission unit and the power reception unit. When the air gap between the power transmission unit and the power reception unit is small during power transfer, coupling coefficient κ is between about 0.6 and about 0.8, for example. Naturally, coupling coefficient κ becomes 0.6 or less depending on the distance between the power transmission unit and the power reception unit. When power transfer is carried out between the power transmission unit and the power reception unit located at a distance from each other, coupling coefficient κ becomes 0.3 or less.

It is to be noted that the coupling between power transmission unit 220 and power reception unit 110 as described above during power transfer is called, for example, “magnetic resonant coupling,” “magnetic field resonant coupling,” “electromagnetic field resonant coupling,” “electric field resonant coupling” or the like. The term “electromagnetic field resonant coupling” means coupling including any of the “magnetic resonant coupling,” the “magnetic field resonant coupling,” and the “electric field resonant coupling.”

When power transmission unit 220 and power reception unit 110 are formed of cods as described above, power transmission unit 220 and power reception unit 110 are coupled to each other mainly through a magnetic field to form the “magnetic, resonant coupling” or “magnetic field resonant coupling.” It is to be noted that an antenna such as a meander line antenna can be employed, for example, as power transmission unit 220 and power reception unit 110. In this case, power transmission unit 220 and power reception unit 110 are coupled to each other mainly through an electric field to form the “electric field resonant coupling.”

(Description of Position Confirmation Control)

In the configuration as described above where the moving device is used to arrange the power reception unit in the standby position during normal running and to lower and bring, the power reception unit closer to the power transmission unit during power transfer various parameters such as the inductances of the coils and the capacitances of the capacitors are designed so as to attain excellent coupling between the power transmission unit and the power reception unit when they are close to each other. Accordingly, when the power reception unit is in the standby position, the distance between the power transmission unit and the power reception unit is greater than the designed value, which may result in inability to sufficiently receive the power output from the power transmission unit. As a result, when parking the vehicle in the predetermined position in the parking space, it may be difficult to detect the position of the power transmission unit by utilizing the power transfer efficiency based on the power received by the power reception unit.

Particularly, when the link mechanism is used for the moving device as shown in FIG. 2, the moving device changes in position in the horizontal direction as it moves up and down in a vertical direction. In such a case, therefore, even if the position of the power transmission unit is confirmed by means of the power reception unit being in the standby position, the relative positional relation in the actual power reception position where the power transmission unit and the power reception unit are close to each other cannot be ensured.

During the parking operation, it is possible to confirm the position of the power transmission unit by means of the power reception unit by lowering the power reception unit in advance by the moving device to a height corresponding to the power reception position. However, if the height of an upper surface of the power transmission unit is higher than expected, or if there is an object such as a curb projecting from the ground, there is a danger that the power reception position will collide against this object and be damaged during the parking operation. Thus, in a vehicle having the configuration as described above, it is difficult to accurately detect the position of the power transmission unit by means of the power reception unit during the parking operation.

In this embodiment, therefore, the vehicle is provided with a detector for detecting the power transmission unit separately from the power reception unit, and the position of the power transmission unit is detected by means of this added detector during the parking operation (hereinafter also referred to as “first detection operation”). Furthermore, after the power reception unit has been moved to the power reception position by the moving device upon completion of the parking, the position of the power transmission unit is detected by utilizing the power transfer efficiency based on the power received by the power reception unit (hereinafter also referred to as “second detection operation”). Then, in response to detection that the position of the power transmission device is within the predetermined range in both the first detection operation and the second detection operation, power transmission is started for charging the power storage device. Such position confirmation control using the two-stage position detection operation can prevent the power transmission from being carried out with the power transfer efficiency remaining low.

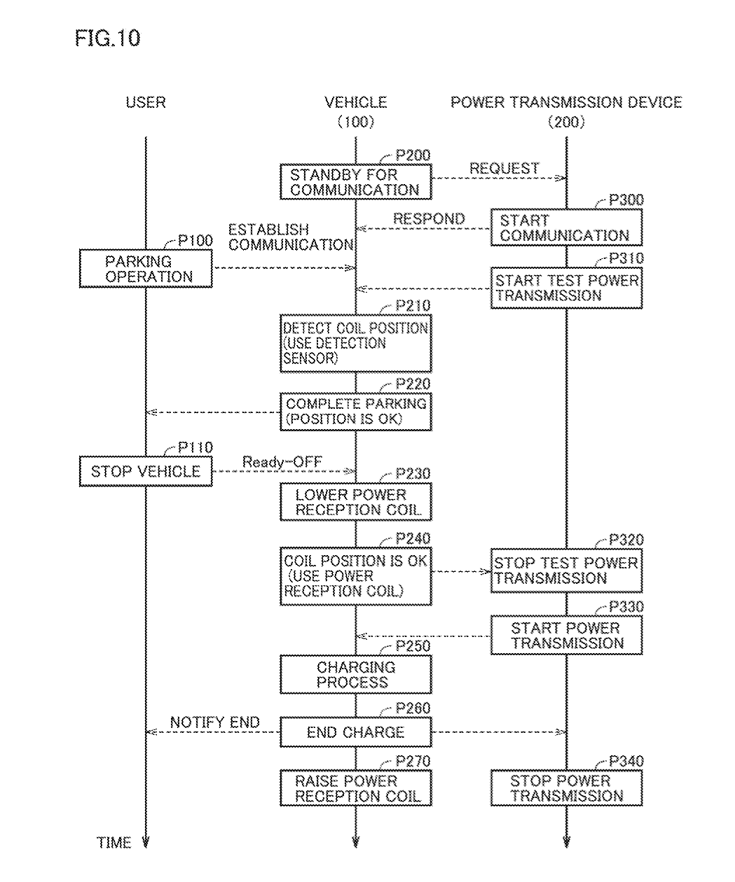

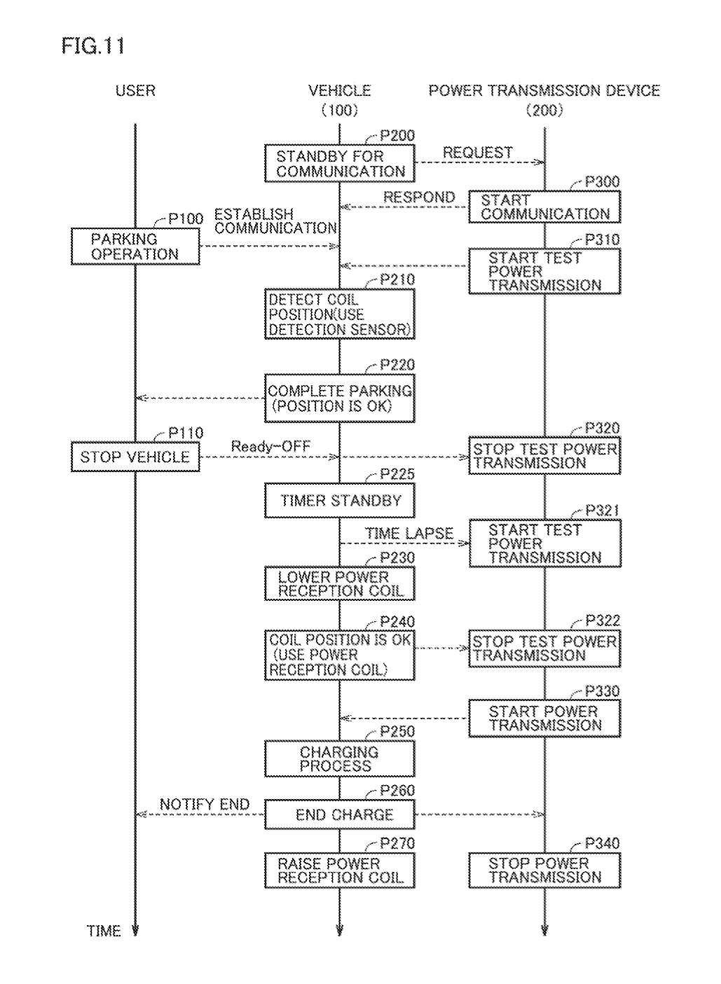

Referring now to FIGS. 10 to 12, the position confirmation control of the power transmission device in this embodiment is described.

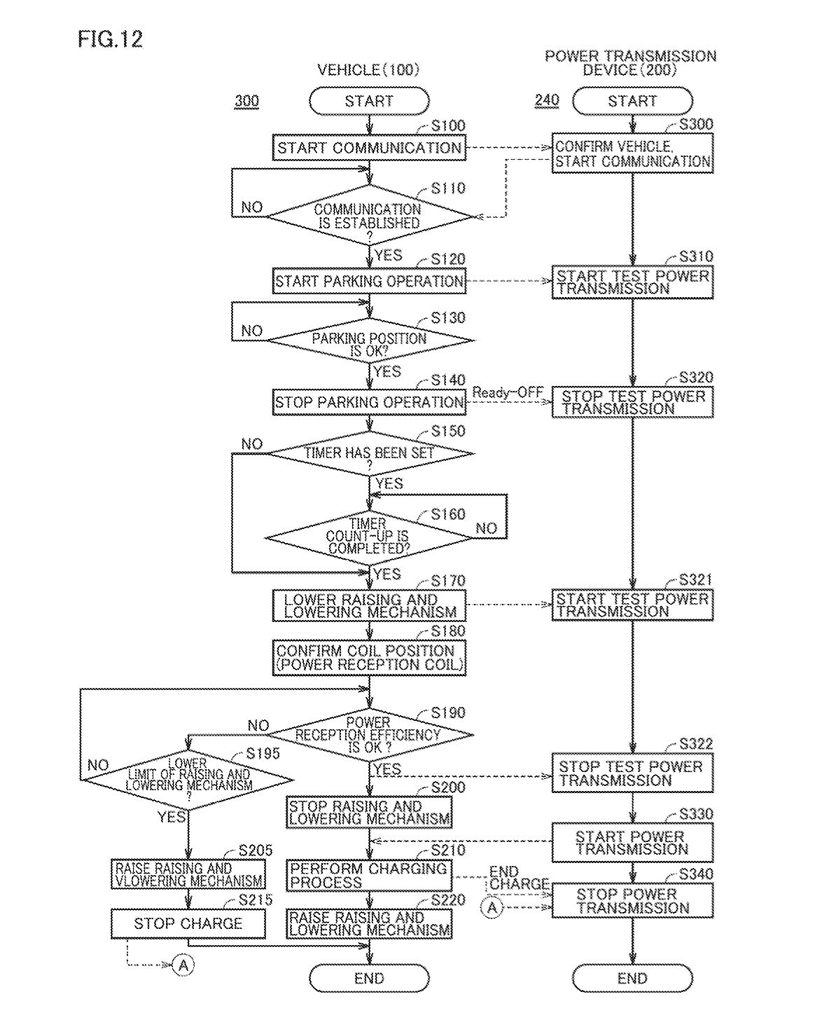

FIGS. 10 and 11 are time charts illustrating a summary of charging operation in this embodiment. FIG. 10 is a time chart when the charging operation is performed subsequent to the parking of the vehicle. FIG. 11 is a time chart when a timer function is used based on the user setting to start the charging operation after a lapse of a predetermined time after the parking of the vehicle. In FIGS. 10 and 11, the vertical axis represents time, to schematically illustrate temporal operations of the user, vehicle 100 and power transmission device 200.

Referring to FIGS. 1 and 10, when vehicle 100 approaches the parking space provided with power transmission device 200 so as to charge power storage device 190, vehicle 100 on standby for communication transmits a request signal for establishing communication (P200). In response, power transmission device 200 transmits a response signal for starting communication to vehicle 100 (P300), whereby the communication is established between vehicle 100 and power transmission device 200.

Then, when the user starts the parking operation (P100), power transmission device 200 starts the test power transmission for parking alignment (P310). Vehicle 100 detects with position detection sensor 165 a magnetic field generated by the test power transmission, and determines whether or not power transmission unit 220 is located within the predetermined range (first predetermined range) from power reception unit 110 based on an output from position detection sensor 165 (P210). When vehicle 100 determines that power transmission unit 220 is located within the predetermined range from power reception unit 110, vehicle 100 prompts the user to park the vehicle. When vehicle 100 has an automatic parking function, vehicle 100 performs the parking operation based on this recognition. It is to be noted that the power output during the test power transmission is set to be smaller than the power during charging of power storage device 190.

When the parking operation to the predetermined position is completed, vehicle 100 determines whether or not power transmission unit 220 is located within the predetermined range from power reception unit 110 based on an output from position detection sensor 165, and when power transmission unit 220 is located within the predetermined range, vehicle 100 transmits a signal indicating the completion of the parking to the user (P220). In response, the user stops vehicle 100 and performs operation of stopping vehicle 100 by operating an ignition switch or an ignition key, causing vehicle 100 to enter a Ready-OFF state (P110). Then, vehicle 100 operates raising and lowering mechanism 105 to lower power reception unit 110 to the position facing power transmission unit 220 (power reception position) (P230).

When the arrangement of power reception unit 110 in the power reception position is completed, vehicle 100 receives, with power reception unit 110, the power of the test power transmission from power transmission unit 220, and confirms again whether or not the positional relation between power transmission unit 220 and power reception unit 110 is within the predetermined range (second predetermined range) based on the power transfer efficiency (power reception efficiency) (P240). When power transmission unit 220 and power reception unit 110 have excellent positional relation, vehicle 100 transmits a signal to that effect to power transmission device 200. In response, power transmission device 200 stops the test power transmission (P320).

Subsequently, power transmission device 200 starts to transmit power for charging power storage device 190 (P330). Vehicle 100 receives with power reception unit 110 the power transmitted from power transmission device 200, and performs a process of charging power storage device 190 (P250).

When the charge is completed because power storage device 190 has been fully charged, or when the end of the charging operation is indicated by the user's operation, vehicle 100 stops the charging operation and notifies the user and power transmission device 200 of the end of the charge (P260). Then, vehicle 100 operates raising and lowering mechanism 105 to return power reception unit 110 to the standby position (P270). Meanwhile, power transmission device 200 stops the power transmission operation based on the notification of the end of the charge from vehicle 100 (P340).

In the description above, the detection of the position of power transmission unit 220 by means of position detection sensor 165 in P210 corresponds to the “first detection operation” described above. The detection of the position of power transmission unit 220 by utilizing the power transfer efficiency based on the power received by power reception unit 110 in P240 corresponds to the “second detection operation” described above.

Referring now to FIG. 11, a process using a timer function is described. In FIG. 11, operation P225 is added to the time chart of FIG. 10. Description of the operations the same as those in FIG. 10 will not be repeated in FIG. 11.

Referring to FIGS. 1 and 11, when the parking operation to the predetermined) position in the parking space is completed in the first detection operation (P210), vehicle 100 transmits a signal indicating the completion of the parking to the user (P220). In response, the user stops vehicle 100 and performs operation of stopping vehicle 100 by operating the ignition switch or the ignition key, causing vehicle 100 to enter the Ready-OFF state (P110). Then, vehicle 100 calculates a time until the start of charge based on a time to start the charge or a time to complete the charge that has been set by the user. Here, in response to the transition to the Ready-OFF state, power transmission device 200 stops the test power transmission (P320). Then, vehicle 100 delays the start of actual charging operation as a standby state until after a lapse of the calculated time until the start of the charge (P225).

When the time to start the charge comes upon the lapse of the aforementioned time, vehicle 100 notifies power transmission device 200 to restart the test power transmission (P321), and lowers raising and lowering mechanism 105 to the power reception position to bring power reception unit 110 closer to power transmission unit 220 (P230).

When power transmission device 200 starts the test power transmission, vehicle 100 calculates the power transfer efficiency based on the power received by power reception unit 110 and information about the power transmitted from power transmission device 200, and confirms whether or not power transmission unit 220 is within the predetermined range (second predetermined range) from power reception unit 100 in the power reception position (P240).

When power transmission unit 220 and power reception unit 100 have excellent positional relation, vehicle 100 causes power transmission device 200 to stop the test power transmission (P322). After stopping the test power transmission, power transmission device 200 starts to transmit power greater than the power for the test power transmission so as to charge power storage device 190 (P330). Then, vehicle 100 performs a process of charging power storage device 190 with the power received from power transmission device 200 (P250).

Subsequently, in a manner similar to that described with reference to FIG. 10, the charge ends (P260), power reception unit 110 is returned to the standby position (P270), and power transmission device 200 stops the power transmission (P340).

FIG. 12 is a flowchart for illustrating control of readjusting the position of the power reception unit which is performed during the power transfer in this embodiment. Each step in the flowchart shown in FIG. 12 is implemented by executing a program prestored in vehicle ECU 300 or power transmission ECU 240 in a predetermined cycle. Alternatively, some of the steps can be implemented by constructing dedicated hardware (an electronic circuit).

Referring to FIG. 12, in step (the step being abbreviated as S hereinafter) 100, vehicle 100 transmits a request signal for starting communication with power transmission device 200. Power transmission ECU 240 receives this request signal and confirms vehicle 100, then transmits a response signal for starting communication with vehicle 100 to vehicle 100 (S300).

In S110, vehicle ECU 300 determines whether or not the response signal from power transmission device 200 in response to the above request signal has been received, that is, whether or not the communication with power transmission device 200 has been established. When the communication with power transmission device 200 has not been established (NO in S110), the process returns to S110 where vehicle ECU 300 continues to determine whether or not the response signal from power transmission device 200 has been received.

When the communication with power transmission device 200 has been established (YES in S110), the process proceeds to S120 where the parking operation to the parking space provided with power transmission device 200 is started by the user's operation or the automatic parking function. Following the start of the parking operation, power transmission ECU 240 causes power transmission unit 220 to start the test power transmission (S310).

In S130, vehicle ECU 300 determines whether or not the movement to the predetermined parking position has been completed, that is, whether or not power transmission unit 220 is now within the predetermined range (first predetermined range) from power reception unit 110, by detecting with position detection sensor 165 a magnetic force transmitted from power transmission unit 220. When the movement to the predetermined parking position has not been completed (NO in S130), the process returns to S130 where vehicle ECU 300 continues to perform the parking operation while confirming the position by means of position detection sensor 105.

When the movement to the predetermined parking position has been completed (YES in S130), in S140, the parking operation is stopped by the automatic parking, function or the user's operation. Then, in response to the transition to the Ready-OFF state by the user's operation, power transmission ECU 240 stops the test power transmission (S120).

In S150, vehicle ECU 300 determines whether or not a timer has been set by the user. When a timer has not been set by the user (NO in S150), the process proceeds to S170.

When a timer has been set by the user (YES in S150), vehicle ECU 300 delays the start of charging operation until after a lapse of the set time. In S160, vehicle ECU 300 determines whether or not the set timer count-up has been completed and the time to start the charge has come.

When the timer count-up has not been completed and the time to start the charge has not come (NO in S160), the process returns to S160 where vehicle ECU 300 remains in the standby state for the charging operation until the time to start the charge comes. When the time to start the charge comes (YES in S160), on the other hand, the process proceeds to S170.

In S170, vehicle ECU 300 causes power transmission device 200 to start the test power transmission again (S321), and starts to lower raising and lowering mechanism 105 so as to move power reception unit 110 to the power reception position facing power transmission unit 220.

In S180, vehicle ECU 300 receives the power supplied through the test power transmission from power transmission device 200, and calculates the power transfer efficiency (power reception efficiency) so as to confirm whether or not power transmission unit 220 and power reception unit 110 are properly aligned in the power reception position. In S190, depending on whether or not the calculated power transfer efficiency is equal to or greater than a predetermined value, vehicle ECU 300 determines whether or not power transmission unit 220 is within the predetermined range (second predetermined range) from power reception unit 110 in the power reception position.

When the power transfer efficiency is equal to or greater than the predetermined value (YES in S190), the process proceeds to S200 where vehicle ECU 300 stops the operation of lowering raising and lowering mechanism 105, and causes power transmission device 200 to stop the test power transmission (S322). After the test power transmission has been stopped, power transmission ECU 240 starts to transmit power greater than that for the test power transmission (S330). In response, vehicle ECU 300 starts a charging process (S210). Then, when the charging operation ends because power storage device 190 has been fully charged, or based on an indication to stop the charge from the user, vehicle ECU 300 transmits a notification that the charging operation ends to power transmission device 200. Thereafter, vehicle ECU 300 raises raising and lowering mechanism 105 to return power reception unit 110 to the standby position, and ends the communication with power transmission device 220 (S220). Meanwhile, in response to the notification of the end of the charge, power transmission device 220 stops the power transmission to vehicle 100 (S340).

In S190, when the power transfer efficiency is lower than the predetermined value (NO in S190), the process proceeds to S195 where vehicle ECU 300 determines whether or not the position of raising and lowering mechanism 105 has reached a lower limit. The “lower limit” as used herein includes the case where raising and lowering mechanism 105 is at a lower limit of its operable range, and the case where raising and lowering mechanism 105 cannot be lowered any further because power reception unit 110 is in contact with power transmission unit 220 and the like.

When the position of raising and lowering mechanism 105 has not reached the lower limit (NO in S195), the process returns to S190 where vehicle FCC 300 continues to determine whether or not the power transfer efficiency has become equal to or greater than the predetermined value, while performing the operation of lowering raising and lowering mechanism 105.

When the position of raising and lowering mechanism 105 has reached the lower limit (YES in S195), on the other hand, vehicle ECU 300 determines that sufficient power transfer efficiency cannot be obtained within the movable range of raising and lowering mechanism 105, and raises raising and lowering mechanism 105 to return power reception unit 110 to the standby position in S205, then stops the charge of power storage device 190 (S215). In response, power transmission device 200 stops the test power transmission to vehicle 100 (S322).

The above flowchart describes an example of calculating the power transfer efficiency while lowering raising and lowering mechanism 105, and stopping raising and lowering mechanism 105 in response to the power transfer efficiency becoming equal to or greater than the predetermined value. However, when a predetermined fixed position, such as the position where power reception unit 110 is in contact with power transmission unit 220, or the position where the gap between power reception unit 110 and power transmission unit 220 has a predetermined value, is set as the power reception position, it can be determined whether or not the charging operation should be started based on the power transfer efficiency after power reception unit 110 has been moved to the power reception position.

The above flowchart describes an example of stopping the test power transmission from power transmission device 200 in response to the parking operation being stopped, as was described with reference to FIG. 11. However, when the timer function is not used, the second detection operation using power reception unit 110 may be performed while the test power transmission is continued, as was described with reference to FIG. 10. Furthermore, when the timer function is used, the second detection operation may be performed with the power for charging power storage device 190. It is, however, more preferable to use the power for the test power transmission as shown in FIGS. 11 and 12, so as to reduce wasteful release of power during the position confirmation.

Furthermore, when the timer function is used, the timer standby state may be started after the power reception unit has been lowered by the raising and lowering mechanism upon completion of parking to perform the second detection operation, and then the power reception unit has been returned to the standby position by raising the raising and lowering mechanism.

By performing the control in accordance with the process as described above, during the parking operation, the stop position (the position of the power transmission unit) can be determined by means of the position detection sensor with the power reception unit being in the standby position, and after the power reception unit has been moved to the power reception position, the start of the charging operation can be determined based on the calculated power transfer efficiency. Consequently, the stopping accuracy of the vehicle can be improved during the parking operation, and the charging operation can be prevented from being performed with the power transfer efficiency remaining low. As a result, the power transfer can be carried out while desired power transfer efficiency is ensured in the contactless power feeding system.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

10 contactless power feeding system;
89 power transfer system;
90, 220, 220A power transmission unit;
91, 110 power reception unit;
92, 93, 96, 97 coil;
94, 99, 111, 221 resonant coil;
95, 98, 112, 222 capacitor;
100 vehicle;
105 raising and lowering mechanism;
113, 223 electromagnetic induction coil;
115 SMR;
118 electrical load device,
120 PCU;
130 motor generator;
140 motive power transmission gear;
150 drive wheel;
160, 230 communication unit;
165 position detection sensor;
170 matching device;
150 rectifier;
190 power storage device;
195 voltage sensor;
196 current sensor;
200 power transmission device;
210 power supply device;
225 ferrite core;
240 power transmission;
250 power supply unit;
260 impedance matching unit;
300 vehicle ECU;
400 commercial power supply.

1. A vehicle capable of receiving power from a power transmission device in a contactless manner, comprising:
a power reception unit that receives power from a power transmission unit included in the power transmission device in a contactless manner;
a moving device configured to move the power reception unit from a standby position in a direction toward the power transmission unit; and
a control device configured to perform first detection operation of detecting a position of the power transmission unit when the power reception unit is located in the standby position, and second detection operation of detecting a position of the power transmission unit when the power reception unit is located in a position closer to the power transmission unit than in the standby position,
the control device causing the power transmission device to start power transmission, when it is detected that the power transmission unit is located within a first predetermined range in the first detection operation and when it is detected that the power transmission unit is located within a second predetermined range in the second detection operation.

2. The vehicle according to claim 1, further comprising a detection unit for detecting the power transmission unit, wherein
the control device performs the first detection operation by means of the detection unit, and performs the second detection operation by means of the power reception unit.

3. The vehicle according to claim 2, wherein
when the vehicle is located in a position capable of receiving the power transmission from the power transmission device, a distance between the detection unit and the power transmission unit is shorter than a distance between the standby position and the power transmission unit.

4. The vehicle according to claim 2, wherein
the control device performs the second detection operation alter the power reception unit has been moved to a planned position where power reception is started.

5. The vehicle according to claim 2, wherein
the detection unit includes a plurality of magnetic sensors configured to detect magnetism of an electromagnetic field generated by the power transmission from the power transmission unit, and
the control device recognizes the position of the power transmission unit based on distribution of the magnetism detected by the plurality of magnetic sensors.

6. The vehicle according to claim 1, wherein
the control device is configured to cause the power transmission unit to start the power transmission in accordance with a timer value, the timer value being determined based on information about a time to start the power transmission set by a user, and
the control device performs the second detection operation in response to lapse of a time corresponding to the timer value.

7. The vehicle according to claim 1, wherein
a difference between a natural frequency of the power transmission unit and a natural frequency of the power reception unit is ±10% or less of the natural frequency of the power transmission unit or the natural frequency of the power reception unit.

8. The vehicle according to claim 1, wherein
a coefficient of coupling between the power transmission unit and the power reception unit is not less than 0.6 and not more than 0.8.

9. The vehicle according to claim 1, wherein
the power reception unit receives power from the power transmission unit through at least one of a magnetic field formed between the power reception unit and the power transmission unit and oscillating at a specific frequency, and an electric field formed between the power reception unit and the power transmission unit and oscillating at a specific frequency.

10. A contactless power feeding system that supplies power from a power transmission unit to a power reception unit in a contactless manner, comprising:
a moving device configured to move at least one of the power transmission unit and the power reception unit from a standby position in a direction in which the power transmission unit and the power reception unit are brought closer to each other; and
a control device configured to perform first detection operation of detecting positional relation between the power transmission unit and the power reception unit when the power transmission unit and the power reception unit are located in the standby positions, and second detection operation of detecting the positional relation when a distance between the power transmission unit and the power reception unit is shorter than the distance with the power transmission unit and the power reception unit being in the standby positions,
the control device causing the power transmission unit to start power transmission, when it is detected that the positional relation satisfies a first predetermined condition in the first detection operation and when it is detected that the positional relation satisfies a second predetermined condition in the second detection operation.
